(19) United States
(12) Patent Application Publication
(10) Pub. No.: US 2023/0385769 A1
(43) Pub. Date: Nov. 30, 2023

(54) NOTIFYING CONTENT EXPERT OF CONTENT CREATED BY USER OUTSIDE COLLABORATION CIRCLE OF CONTENT EXPERT

(71) Applicant: MICROSOFT TECHNOLOGY LICENSING, LLC, Redmond, WA (US)

(72) Inventors: Torbjørn Helvik, Oslo (NO); Jan-Ove Karlberg, Tromsø (NO); Jon Meling, Tromsø (NO)

(73) Assignee: MICROSOFT TECHNOLOGY LICENSING, LLC, Redmond, WA (US)

(21) Appl. No.: 17/664,918

(22) Filed: May 25, 2022

(51) Int. Cl. G06Q 10/10; G06Q 10/06; G06F 40/211; G06F 40/295; G06N 5/02

(52) U.S. Cl. CPC G06Q 10/103; G06Q 10/0639; G06F 40/211; G06F 40/295; G06N 5/022

(57) ABSTRACT

Examples of the present disclosure describe systems and methods for notifying users of content creation related to existing content expertise. In examples, content associated with a data domain is evaluated to determine the topics associated with the content. User activity for the data domain is monitored to determine user knowledge levels on various topics. User collaboration circles are determined based on interactions between users. When new content is detected, topics in the new content are evaluated and users having knowledge on the topics are identified based on the determined knowledge levels. The users having knowledge on the topics are ranked based in part on their collaboration circles. At least a portion of the ranked users having knowledge on the topics are notified of the new content creation and/or the users creating the new content are notified of the ranked users having knowledge on the topics.

### BACKGROUND

It is typically beneficial for organizations to share knowledge and expertise among their various members. However, in many organizations, it can be difficult to keep track of the knowledge and expertise of the members and to make this knowledge and expertise available to the members. Even in a scenario in which a knowledge repository is maintained by an organization, many members may not remember to use the knowledge repository or may choose to not use the knowledge repository for various reasons.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for notifying users of content creation related to existing content expertise. In examples, content associated with a data domain is evaluated to determine the topics associated with the content. User activity for the data domain is monitored to determine the knowledge levels of users on various topics. The determined knowledge levels are maintained in an index. A collaboration circle of each user is determined based on interactions between the user and other users. In response to detecting new content creation, the topics in the new content are determined and evaluated against the topics in the index to identify users having knowledge on the topics. The users having knowledge on the topics are ranked based in part on their collaboration circles. At least a portion of the ranked users having knowledge on the topics are notified of the new content creation and/or the users creating the new content are notified of the ranked users having knowledge on the topics.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Examples are described with reference to the following figures.

FIG. 1 illustrates an overview of an example system for notifying users of content creation related to existing content expertise.

FIG. 2 illustrates an example content expert surfacing system for notifying users of content creation related to existing content expertise.

FIG. 3 illustrates an example method for notifying users of content creation related to existing content expertise.

FIG. 4 is a block diagram illustrating example physical components of a computing device for practicing aspects of the disclosure.

FIGS. 5A and 5B are simplified block diagrams of an example mobile computing device for practicing aspects of the present disclosure.

FIG. 6 is a simplified block diagram of an example distributed computing system for practicing aspects of the present disclosure.

FIG. 7 illustrates an example tablet computing device for executing one or more aspects of the present disclosure.

### DETAILED DESCRIPTION

Many organizations, groups, departments, and similar business entities (collectively referred to herein as “organizations”) realize substantial benefits from sharing knowledge and expertise among members within an organization (e.g., intra-organization) and between members of separate organizations (e.g., inter-organization). However, in many organizations, especially larger organizations, it can be difficult to keep track of the knowledge and expertise of the organization's members for several reasons, such as the influx of new members (e.g., new hires and organizational mergers/acquisitions), the outflux of existing members (e.g., retirements, reassignments, down-sizing), skill set modifications (e.g., members acquiring new or updated skill sets or losing existing skills due to disuse or changes in technology), and member decentralization (e.g., increases in remote and geographically dispersed organization members).

Additionally, even when an organization makes an effort to track the knowledge and expertise of the organization's members, it can be difficult for the organization to make this knowledge and expertise available to the members. For example, some organizations create a knowledge repository to store the knowledge and expertise of the organization's members. However, the organizations do not always adequately maintain the knowledge repositories, which causes the information in the knowledge repositories to become out-of-date and less effective. Further, many members do not remember to use the knowledge repository or choose to not use the knowledge repository because the knowledge repository is, for example, inaccessible (e.g., difficult to access and/or use), ineffective (e.g., does not provide the desired results or in the desired format), or time-consuming. Thus, many organization members are unable to benefit from the knowledge and expertise of their fellow members.

Embodiments of the present disclosure address challenges of the knowledge and expertise sharing solutions discussed above and provide systems and methods for notifying users of content creation related to existing content expertise. In examples, content (e.g., documents, web pages, communications, videos, images, audio, gestures) associated with one or more data domains is evaluated to determine topics associated with the content. A data domain, as used herein, refers to a logical grouping of information relating to a common topic, purpose, or theme. As a specific example, a data domain for an organization includes the content created or controlled by the organization and the organizational knowledge of the members of the organization. A data domain may comprise subdomains or be comprised by a super-domain. Evaluating the content may comprise using machine learning (ML) and/or other automated techniques to scan the content and/or metadata of the content for topics of the content, and assigning the topics to one or more portions (e.g., words, sentences, sections, pages) of the content. A topic, as used herein, refers to a phrase or term that is significant or important to an organization. The content and/or topics associated with a data domain may be stored in one or more data repositories, such as an enterprise knowledge graph, a graph database, or another type of data store.

In alternative examples, instead of determining the topics associated with the content of a data domain, an existing taxonomy for the data domain is used. In such examples, the taxonomy comprises a collection of topics associated with content of the data domain. Each of the topics in the taxonomy are identified by a unique identifier. In at least one example, the taxonomy also comprises associations between topics and the content in which the topics were found. For instance, the taxonomy may comprise mappings that correlate each topic in the taxonomy to each document in which the topic was found or referenced.

User activity for the data domain is monitored over time to determine the knowledge levels of users on the various topics associated with the data domain. Examples of user activity include creating content, modifying content, accessing or viewing content, sending content, receiving content, navigating content (e.g., scrolling, clicking, panning, zooming), and commenting on content. Monitoring the user activity includes applying event detection techniques to services and/or applications associated with the data domain. To determine the knowledge levels of a user, the content associated with the user's user activity is evaluated to determine the topics associated with the content, as discussed above. The user's knowledge level for each of the determined topics is then determined based on one or more factors, such as the amount of communication the user has engaged in regarding the topic, the number of other users with whom the user has communicated about the topic, the amount of time over which communications about the topic have occurred, the recency of communications about the topic, the amount of content created by the user that includes the topic, the type of the user activity (e.g., content authoring, content viewing, content receiving), the amount of time the user spent navigating the topic within the content, etc. In examples, a user's knowledge level for a topic is assigned a value based on evaluation of the factors discussed above. The value may be a label (e.g., unfamiliar, beginner, intermediate, advanced, expert), a numerical value (e.g., a number, a percentage, a range of numbers), or another type of designation.

The determined knowledge levels of users on the topics associated with the user activity are maintained in an index or a similar data structure for the data domain. An index, as used herein, refers to a data structure that facilitates the efficient lookup of data (e.g., terms, phrases, values, key-value pairs) stored by the data structure. In one example, the index includes tuples for multiple users in the data domain, where each tuple comprises a user, a topic, and the user's knowledge level of the topic. The index can be updated in real-time in response to the detection of user activity and/or at predefined time intervals (e.g., hourly, daily, weekly).

A collaboration circle of each user in the data domain is determined based on interactions between the user and other users in the data domain. A collaboration circle, as used herein, refers to a group of peers or members of an organization who share common interests, goals, tasks, or knowledge. In examples, a collaboration circle is determined by evaluating the communications of the user (e.g., email messages, chat messages, text messages, meeting documents and transcriptions, phone calls) and the user activity of the user (e.g., co-authored content, comments within content, @mentions). As one example, a collaboration circle can be inferred from the number of communications between a user and other users. The inference can be based on a predetermined threshold value (e.g., five (5) communications), a predetermined threshold value within a period of time (e.g., five (5) communications within one week), a relative value (e.g., twice as many communications to user ‘X’ as to user ‘Y’ and user ‘Z’), or any other criteria. As another example, a collaboration circle can be inferred from the length of communications between a user and other users (e.g., the length of the text of the communication or the duration of the communication) or from the type of communications between a user and other users (e.g., email message, phone call, in-person meeting). The collaboration circle of each user is stored in a data repository, such as the data repository discussed above.

In response to detecting new user activity for the data domain, the content associated with the new user activity is evaluated to determine the topics associated with the content, as discussed above. The topics associated with the new user activity are evaluated against the topics in the index for the data domain. The evaluation comprises the use of pattern matching (e.g., regular expressions, string searching algorithms, fuzzy logic). When topics associated with the new user activity are determined to match (or be similar to) topics in the index, a list of candidate users and their knowledge levels for the matched topics is generated. In some examples, the evaluation further comprises determining whether the candidate users in the list of candidate users have access to the content associated with the new user activity. For instance, a candidate user may be omitted or removed from the list of candidate users if it determined that the candidate user cannot access a document being created due to, for example, the candidate user not being a member of a group or the organization of the user creating the document or the candidate user lacking security clearance for the document.

A ranking technique (e.g., ML, artificial intelligence (AI), or a ranking algorithm) is then used to rank the list of candidate users based on factors, such as the degree of overlap between a matched topic and a candidate user's areas of knowledge, the level of a candidate user's knowledge on the matched topic, the number of candidate user's having knowledge of the matched topic, whether the candidate user is outside the collaboration circle of the user associated with the new user activity, and whether the candidate user has acted on candidate selection notifications previously. In at least example, the ranking technique comprises applying weights to ranking factors, generating ranking factor scores, and/or generating candidate user scores. For instance, a user's level of knowledge on a topic may be assigned a higher weight (and, thus, be considered a more relevant or important ranking factor) than the amount of time a user has been with the organization. As a specific example, a user's level of knowledge on a topic may be assigned a weight of 0.8, whereas the amount of time a user has been with the organization may be assigned a weight of 0.3 (where higher weighting value indicate higher importance). The weights, factor scores, and/or other considerations may be used to generate a candidate score for each candidate user. Based on the ranking of the list of candidate users, one or more of the candidate users is selected. For instance, candidate users having the highest rankings (e.g., the top ‘N’ or ‘N’% of candidate users) may be selected from the list of candidate users. In examples, the selected user(s) have the highest level of knowledge on the matched topic, or are experts on the matched topic and are outside the collaboration circle of the user associated with the user activity.

In examples, a selected user is provided a notification about content associated with the new user activity. For instance, a selected user is provided a notification that a document within the selected user's area of expertise is currently being composed by a user. The notification may comprise the name of the content (or another content identifier), topics in the content, the name of the authoring user, an identifier of the authoring user's organization, a means to contact the authoring user (e.g., an email address, a phone number, a hyperlink to a contact page), and other metadata about the content (e.g., creation date/time, modification date/time, file size). Examples of notifications include email messages, text messages, organization internal feeds, pop-ups, and the like. In some examples, one or more notifications can be provided to one or more selected users while the content is being created or after the content has been completed. For instance, while a first section of a document is being authored, a first notification is provided to a first user who is an expert on the topic of the first section. While a second section of the document is being authored, a second notification is provided to a second user who is an expert on the topic of the second section. In one example, historical observations regarding whether and/or the amount of time before a selected user acts on a notification (e.g., contacts the user of the new user activity) are preserved and used in rankings for the list of candidate users.

In at least one example, a selected user is also provided the content associated with the new user activity. For instance, the selected user may be provided a snapshot of the content as the content existed at the time the content was last evaluated to determine the topics associated with the content. The snapshot may be updated periodically as the new user activity continues. Alternatively, the selected user may be provided a real-time view of the content as the new user activity continues. For instance, the selected user may be provided a user interface that actively mirrors the display screen of a user that is authoring a document. In such an example, users of the organization may be required to “opt-in” or otherwise consent to collection, storage, and/or evaluation of their user activity. In an example, instead of providing the entire content to a selected user, only a portion of the content associated with the new user activity is provided to the selected user. For instance, only the portion(s) of the document that relate to the selected user's knowledge area (e.g., a paragraph, a section, a page, a sentence) may be provided to the selected user. In examples, providing notifications and content to the selected users enable users who are knowledgeable about certain topics to selectively offer their assistance to less knowledgeable users who are creating content related to those topics and who are outside the collaboration circle of the selected users.

In some examples, the user associated with the new user activity is provided a notification about the selected user(s). For example, as the user is composing the content (or after the content has been completed), one or more notifications can be provided to the user about selected users that are knowledgeable about topics in the content. In one example, the notifications include the name of the selected user, background information for the selected user (e.g., a bio, a resume, accolades, areas of expertise, relevant experience), relevant content authored or modified by the selected user, a means to contact the selected user (e.g., an email address, a phone number, a hyperlink to a contact page), and/or the candidate score for the selected user. In one example, the notifications also include the names of one or more members of the user's collaboration circle who know or are associated with the selected user. In such an example, the notification may provide a suggestion or an option to request that the member who knows or is associated with the selected user provide the user with an introduction to the selected user. Such notifications enable users who are creating content relating to certain topics to selectively solicit assistance from users who are knowledgeable about those topics and who are outside the collaboration circle of the users who are creating content.

Thus, the present disclosure provides a plurality of technical benefits and improvements over previous knowledge and expertise sharing solutions. These technical benefits and improvements include: automatically associating content in a data domain with one or more topics; improving assessment of user knowledge levels with topics, a dedicated index for storing relationships between user, topics, and user knowledge levels for the topics; determining collaboration circles for users based on user interactions; dynamically matching content being generated to knowledgeable users that may not have already been known to the author of the content being generated; omitting knowledgeable users that do not have permission to access content being generated; proactively notifying topic experts of new and modified content relating to their areas of expertise; and proactively notifying content creators of users knowledgeable on the topics in the content being created, among other examples.

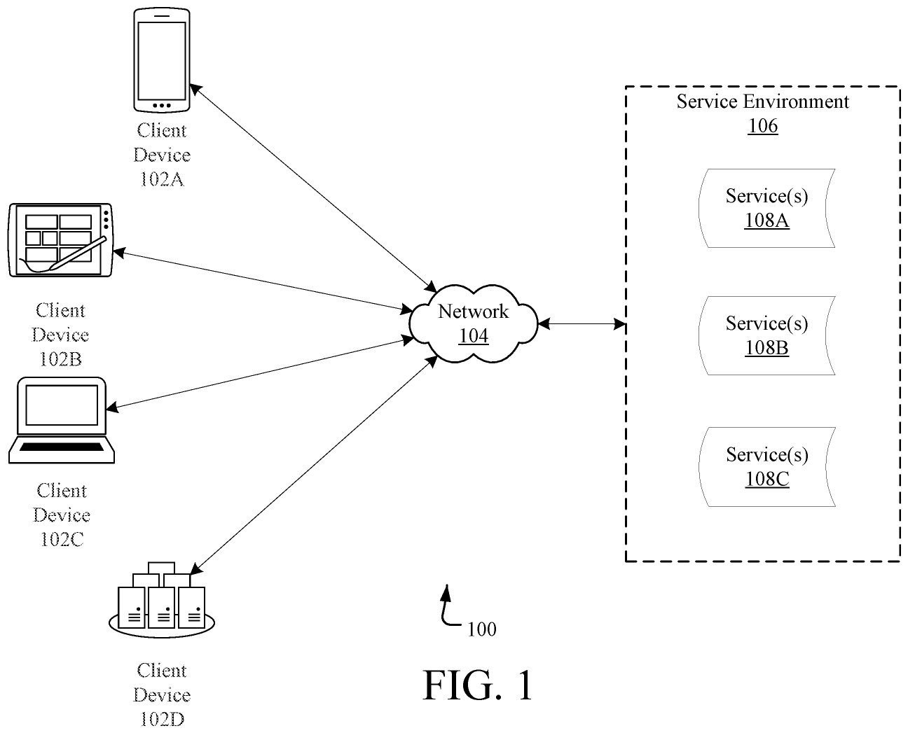

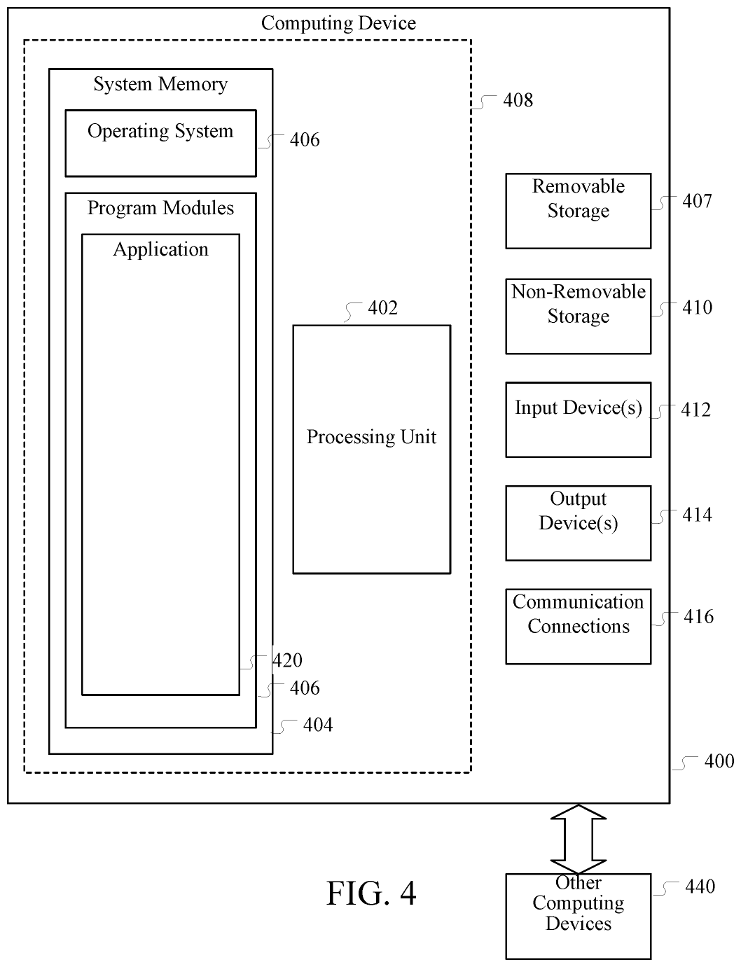

FIG. 1 illustrates an overview of an example system for notifying users of content creation related to existing content expertise. Example system 100 as presented is a combination of interdependent components that interact to form an integrated whole. Components of system 100 may be hardware components or software components (e.g., applications, application programming interfaces (APIs), modules, virtual machines, or runtime libraries) implemented on and/or executed by hardware components of system 100. In one example, components of systems disclosed herein are implemented on a single processing device. The processing device may provide an operating environment for software components to execute and utilize resources or facilities of such a system. An example of processing device(s) comprising such an operating environment is depicted in FIGS. 4-7. In another example, the components of systems disclosed herein are distributed across multiple processing devices. For instance, input may be entered on a user device or client device and information may be processed on or accessed from other devices in a network, such as one or more remote cloud devices or web server devices.

In FIG. 1, system 100 comprises client devices 102A, 102B, 102C, and 102D (collectively “client device(s) 102”), network 104, service environment 106, and service(s) 108A, 108B, and 108C (collectively “service(s) 108”). One of skill in the art will appreciate that the scale and structure of systems such as system 100 may vary and may include additional or fewer components than those described in FIG. 1. As one example, service environment 106 and/or service(s) 108 may be incorporated into client device(s) 102.

Client device(s) 102 may be configured to detect and/or collect input data from one or more users or user devices. In some examples, the input data corresponds to user interaction with one or more software applications or services implemented by, or accessible to, client device(s) 102. In other examples, the input data corresponds to automated interaction with the software applications or services, such as the automatic (e.g., non-manual) execution of scripts or sets of commands at scheduled times or in response to predetermined events. The user interaction or automated interaction may be related to the performance of user activity corresponding to a task, a project, a data request, or the like. The input data may include, for example, audio input, touch input, text-based input, gesture input, and/or image input. The input data may be detected/collected using one or more sensor components of client device(s) 102. Examples of sensors include microphones, touch-based sensors, geolocation sensors, accelerometers, optical/magnetic sensors, gyroscopes, keyboards, and pointing/selection tools. Examples of client device(s) 102 include personal computers (PCs), mobile devices (e.g., smartphones, tablets, laptops, personal digital assistants (PDAs)), wearable devices (e.g., smart watches, smart eyewear, fitness trackers, smart clothing, body-mounted devices, head-mounted displays), and gaming consoles or devices, and Internet of Things (IoT) devices.

Client device(s) 102 may provide the input data to service environment 106. In some examples, the input data is provided to service environment 106 using network 104. Examples of network 104 include a private area network (PAN), a local area network (LAN), a wide area network (WAN), and the like. Although network 104 is depicted as a single network, it is contemplated that network 104 may represent several networks of similar or varying types. In some examples, the input data is provided to service environment 106 without using network 104.

Service environment 106 is configured to provide client device(s) 102 access to various computing services and resources (e.g., applications, devices, storage, processing power, networking, analytics, intelligence). Service environment 106 may be implemented in a cloud-based or server-based environment using one or more computing devices, such as server devices (e.g., web servers, file servers, application servers, database servers), edge computing devices (e.g., routers, switches, firewalls, multiplexers), personal computers (PCs), virtual devices, and mobile devices. Alternatively, the service environment 106 may be implemented in an on-premises environment (e.g., a home or an office) using such computing devices. The computing devices may comprise one or more sensor components, as discussed with respect to client device(s) 102. Service environment 106 may comprise numerous hardware and/or software components and may be subject to one or more distributed computing models/services (e.g., Infrastructure as a Service (IaaS), Platform as a Service (PaaS), Software as a Service (SaaS), Functions as a Service (FaaS)). In aspects, service environment 106 comprises or provides access to service(s) 108.

Service(s) 108 may be integrated into (e.g., hosted by or installed in) service environment 106. Alternatively, one or more of service(s) 108 may be implemented externally to service environment 106. For instance, one or more of service(s) 108 may be implemented in a service environment separate from service environment 106 or in client device(s) 102. Service(s) 106 may provide access to a set of software and/or hardware functionality. Examples of service(s) 106 include topic detection and/or classification services, data domain taxonomy services, expertise assessment services, content indexing services, relationship detection and/or inferencing service, content detection services, content expert identification and/or surfacing services, audio signal processing services, word processing services, spreadsheet services, presentation services, document-reader services, social media software or platforms, search engine services, media software or platforms, multimedia player services, content design software or tools, database software or tools, provisioning services, and alert or notification services.

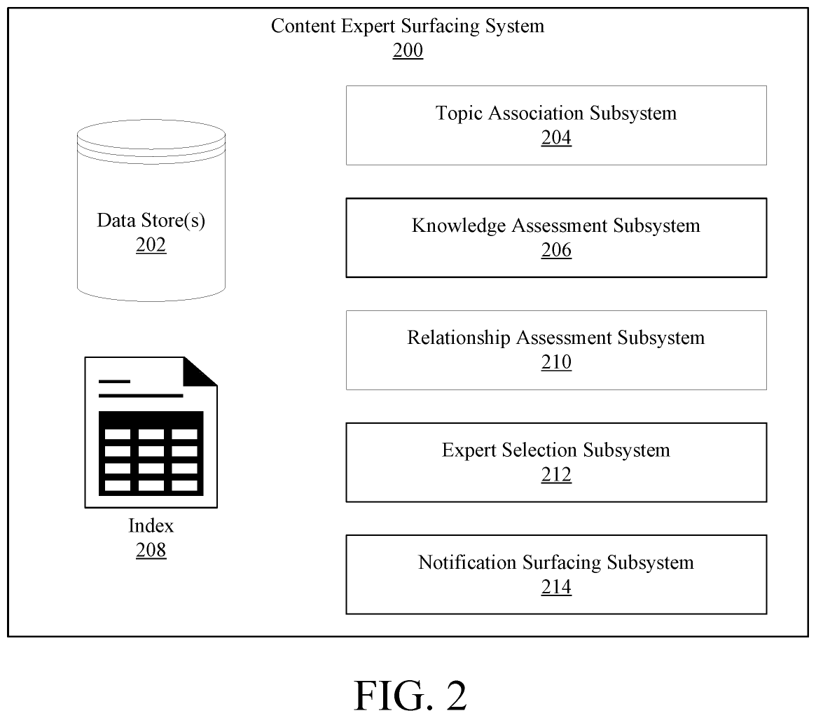

FIG. 2 illustrates an example content expert surfacing system for notifying users of content creation related to existing content expertise. The techniques implemented by content expert surfacing system 200 may comprise the techniques and data described in system 100 of FIG. 1. Although examples in FIG. 2 and subsequent figures will be discussed in the context of content expert surfacing, the examples are equally applicable to other contexts, such as user contact surfacing, organizational knowledge assessment, and user training scenarios. In some examples, one or more components described in FIG. 2 (or the functionality thereof) are distributed across multiple devices or computing systems in one or more computing environments. In other examples, a single device comprises the components described in FIG. 2.

In FIG. 2, content expert surfacing system 200 comprises data store(s) 202, topic association subsystem 204, knowledge assessment subsystem 206, index 208, relationship assessment subsystem 210, expert selection subsystem 212, and notification surfacing subsystem 214. It is to be appreciated that the scale of content expert surfacing system 200 may vary and may include additional or fewer components than those described in FIG. 2. As one example, index 208 may be integrated into data store(s) 204. As another example, data store(s) 204 may be dispersed across multiple organizations and/or data domains. Components and subsystems of content expert surfacing system 200 may be hardware components or software components implemented on and/or executed by hardware components. In examples, content expert surfacing system 200 may be associated with one or more organizations or data domains. In a particular example, content expert surfacing system 200 is an enterprise system for an organization.

Data store(s) 202 are configured to store content associated with a data domain. A data domain may encompass one or more organizations or one or more groups within the organization(s). In examples, content that is associated with a data domain is created, used, and/or controlled by members of the organization associated with the data domain. In some examples, content stored in data store(s) 202 is only accessible to members of the organization associated with the data domain. Data store(s) 202 may store content in various data structures, such as a knowledge graph, a graph database, a relational database, or an ontology structure. Data store(s) 202 may also store metadata associated with the content and/or the data structures.

Topic association subsystem 204 is configured to access content in data store(s) 202 and/or content associated with the data domain associated with data store(s) 202. Topic association subsystem 204 evaluates the accessed content to determine topics associated with (e.g., explicitly indicated by or implicitly referenced by) the content or portions thereof. Evaluating the content may comprise scanning text, image data, audio data, video data, field identifiers, or metadata of the content. As one example, each sentence of a paragraph is evaluated to determine a common topic for the paragraph. As another example, the ‘Subject’ field of an email message is evaluated to determine a topic for the email message. Topic association subsystem 204 associates the determined topics with the content by assigning, mapping, or otherwise correlating the determined topics to the content. For instance, topic association subsystem 204 may create a mapping index that maps each section of a document to a topic. In examples, topic association subsystem 204 stores the determined associations between the content and the topics in data store(s) 202 or an alternative storage location.

Knowledge assessment subsystem 206 is configured to monitor user activity over time to assess user knowledge. In examples, knowledge assessment subsystem 206 implements an event listener function or procedure (or similar functionality). The event listener may be programmed to react to an input or signal indicating the occurrence of a specific event by calling an event handler. Examples of such an event include creating content, modifying content, accessing or viewing content, sending content, receiving content, navigating content, commenting on content. Upon detecting user activity for the data domain, the content associated with the user activity is evaluated to determine the topics associated with the content. In some examples, knowledge assessment subsystem 206 leverages topic association subsystem 204 to determine the topics associated with the content. In other examples, knowledge assessment subsystem 206 comprises functionality similar to (or the same as) the functionality of topic association subsystem 204, and determines the topics associated with the content.

Knowledge assessment subsystem 206 determines a knowledge level of the user(s) associated with the user activity for each of the determined topics of the content. As a specific example, a knowledge level on multiple determined topics in a document may be determined for each co-author of the document and for a commenter of the document (e.g., a user who has provided comments within the document). Knowledge assessment subsystem 206 may determine a knowledge level based on one or more factors. As one example, a knowledge level may be determined based on the amount of communication the user has engaged in regarding the topic. For instance, knowledge assessment subsystem 206 may evaluate user communications (e.g., email messages, chat messages, text messages, meeting documents and transcriptions, phone calls) from communication applications and services of an organization to determine the frequency that a user has communicated about the topic. Knowledge assessment subsystem 206 may also determine the duration of each communication, the amount of the communication that is focused on the topic, and other communication metrics. Knowledge assessment subsystem 206 may then determine a knowledge level for the topic based on the communication metrics (e.g., frequency, duration, focus) such that higher knowledge levels are determined for high levels of communication metrics (e.g., high frequency, high duration, high focus). In examples, the knowledge levels may be represented as text values (e.g., beginner, intermediate, expert), numerical values (e.g., 6 on a scale of 0-10), or another type of designation (e.g., a color, an image, a sound, haptic feedback). Knowledge assessment subsystem 206 assigns the determined knowledge level for the topic to the user.

Knowledge assessment subsystem 206 is further configured to maintain an index 208 of user knowledge levels for topics in the data domain. In examples, knowledge assessment subsystem 206 provides to index 208 information relating to user identity (of the user(s) associated with the user activity), topics, and user knowledge levels on the topics. Index 208 stores the provided information such that efficient lookup of the information can be performed. In a specific example, index 208 stores tuples comprising a user identifier, a topic identifier, and user knowledge level of a topic. In some examples, knowledge assessment subsystem 206 updates index 208 each time user activity for the data domain is detected. In other examples, index 208 is updated according to predefined time intervals.

Relationship assessment subsystem 210 is configured to determine a collaboration circle for users who are members of a data domain. In examples, relationship assessment subsystem 210 accesses user communications and user activity data using applications and services of an organization, such as messaging applications and services, word processing applications and services, and the like. In one example, relationship assessment subsystem 210 also accesses user communications and user activity data using applications and services that are external to the organization. For instance, relationship assessment subsystem 210 may have access to a user's personal computing device, such as mobile phone or a personal laptop. In such an example, users may be required to “opt-in” or otherwise consent to collection, storage, and/or evaluation of their personal user communications and user activity. Relationship assessment subsystem 210 uses the user communications and user activity data to determine the users with whom each user typically communicates. The determination may be based on a total number of communications, a frequency of communications, a length of communications, a topic of communications, or the like. Each user that satisfies a minimum communication or user activity data threshold may be added to a user's collaboration circle. For instance, any member of a data domain with whom a user has communicated at least five times during the last year may be added to the collaboration circle of the user. In examples, relationship assessment subsystem 210 stores the collaboration circles in data store(s) 202 or an alternative storage location.

Expert selection subsystem 212 is configured to detect new user activity for the data domain. Upon detecting new user activity, the content associated with the new user activity is evaluated to determine the topics associated with the content. In some examples, expert selection subsystem 212 leverages knowledge assessment subsystem 206 to detect new user activity and determine topics associated with content. In other examples, expert selection subsystem 212 comprises functionality similar to (or the same as) the functionality of knowledge assessment subsystem 206 and/or topic association subsystem 204. Expert selection subsystem 212 evaluates the topics in the content against the topics in index 208. When a topic in the content is determined to match (or be similar to) a topic in index 208, the user(s) associated with the topic in index 208 and the knowledge levels listed in index 208 for the user(s) are identified. The identified users and their associated knowledge levels are added to a list of candidate users.

Expert selection subsystem 212 ranks the list of candidate users based on one or more factors. As one example, a first factor may be the candidate users' respective knowledge levels on a topic. For instance, candidate users who are indicated as having expert knowledge on a topic may be assigned higher weights or scores than candidate users who are indicated as having intermediate knowledge on the topic. As another example, a second factor may be whether a candidate user is outside the collaboration circle of the user associated with the new user activity, as determined by relationship assessment subsystem 210. For instance, candidate users who are outside the collaboration circle of the user associated with the new user activity may be ranked higher than candidate users who are inside the collaboration circle of the user associated with the new user activity. Alternatively, candidate users who are inside the collaboration circle of the user associated with the new user activity may be removed from the list of candidate users. In some examples, expert selection subsystem 212 selects one or more users from the list of candidate users based on selection criteria, such as selecting all candidate users having expert knowledge, selecting the top ‘N’ or ‘N’% of candidate users, or the like.

Notification surfacing subsystem 214 is configured to surface (e.g., provide) notifications to users selected from the list of candidate users (“selected users”). The notifications may indicate that content associated with new user activity is accessible to the selected users. In examples, a notification comprises the name or identifier of the content, topics in the content, the name of the authoring user, an identifier of the authoring user's organization, a means to contact the authoring user, and/or other metadata about the content. In some examples, the notification also comprises the content associated with the new user activity. For instance, the notification may comprise a snapshot of the content (or a portion thereof) or a hyperlink enabling a selected user to access the content. Alternatively, the content (or the portion thereof) may be provided along with, but external to, the notification. For instance, notification surfacing subsystem 214 may provide a user interface that displays the content. In an example, the user interface enables a selected user to edit, comment on, and/or navigate the content.

Notification surfacing subsystem 214 is further configured to surface notifications to users associated with new user activity. The notifications may indicate that selected users are knowledgeable about one or more topics in the content associated with new user activity. In examples, a notification comprises the name of the selected user, background information for the selected user, relevant content authored or modified by the selected user, a means to contact the selected user, and/or a candidate score for the selected user. In one example, a notification also includes the names of one or more members of the user's collaboration circle who know or are associated with a selected user. In some examples, multiple notifications are provided to a user associated with new user activity during the user activity. For instance, the user is provided a first selected user (an expert on a first topic) while a first section of the document is being authored and the user is provided a second selected user (an expert on a second topic) while a second section of the document ss being authored.

Having described one or more systems that may be employed by the aspects disclosed herein, this disclosure will now describe one or more methods that may be performed by various aspects of the disclosure. In aspects, method 300 may be executed by a system, such as system 100 of FIG. 1. However, method 300 is not limited to such examples. In other aspects, method 300 is performed by a single device or component that integrates the functionality of the components of system 100. In at least one aspect, method 300 is performed by one or more components of a distributed network, such as a web service or a distributed network service (e.g. cloud service).

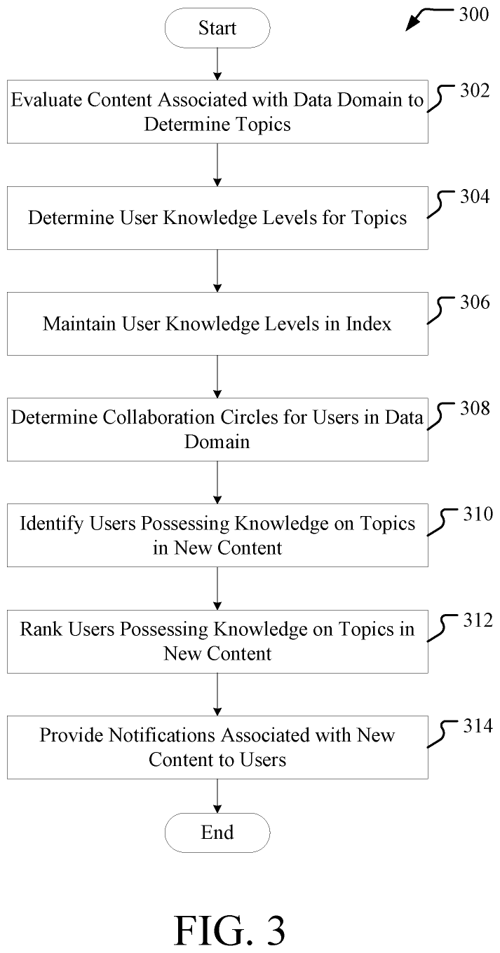

FIG. 3 illustrates an example method for notifying users of content creation related to existing content expertise. Example method 300 begins at operation 302, where content associated with a data domain is evaluated to determine the topics associated with the content. In examples, a topic classification mechanism, such as topic association subsystem 204, accesses a data repository, such as data store(s) 202. In at least one example, the data repository stores content associated with a data domain that encompasses one or more organizations. For instance, a data domain may encompass a single organization or one or more groups (e.g., departments, committees, teams) or knowledge areas (e.g., computer vision, data security, network analysis) within the organization. Alternatively, a data domain may encompass multiple organizations, such as where a first organization is an affiliate of or a consultant to a second organization.

The topic classification mechanism evaluates the content stored in the data repository to determine topics associated with the content. Evaluating the content may comprise using ML-based text and/or speech analysis techniques, such as named entity recognition, speech tagging, and syntactic parsing to scan the content or portions of the content. As one example, the analysis techniques may be applied to one or more paragraphs within the content such that each sentence in the paragraph(s) is evaluated to determine a common topic for the paragraph(s). In another example, the analysis techniques are applied to section identification information of the content (e.g., content titles, section titles and identifiers, table of contents) and data fields of the content, such as a ‘Subject’ field of an email message. In another example, the analysis techniques are applied to metadata of the content, such as content keywords, content summary, and content file name. Based on the evaluation of the content, one or more topics are determined for the content and/or one or more sections of the content. The one or more determined topics are then associated with (e.g., assigned to) the content or section(s) of the content. In some examples, the content-topic associations are stored in the data repository. The content-topic associations may be stored in a topic classification system (e.g., as an ontology mapping), a knowledge graph, a graph database, or the like.

At operation 304, user knowledge levels are determined for topics associated with content. In examples, user activity for the data domain is monitored by a monitoring component, such as provided by knowledge assessment subsystem 206. Upon detecting user activity for the data domain, the content associated with the user activity is evaluated using, for example, the topic classification mechanism to determine the topics associated with the content. A knowledge determination mechanism, such as knowledge assessment subsystem 206, determines a knowledge level of each user associated with the content for each of the determined topics of the content. A user's knowledge level for a topic is based on one or more factors, such as the amount of communication the user has engaged in regarding the topic, the number of other users with whom the user has communicated about the topic, the amount of time over which communications about the topic have occurred, the recency of communications about the topic, the amount of content created by the user that includes the topic, the type of the user activity (e.g., content authoring, content viewing, content receiving), and the amount of time the user spent navigating the topic within the content.

At operation 306, the determined user knowledge levels are maintained in an index. In examples, the knowledge determination mechanism may create an index, such as index 208, and/or provide information relating to the user activity to the index. The information relating to the user activity may include user identity information for each user associated with the user activity, each topic determined to be associated with the content that is associated with the user activity, and user knowledge levels on each topic determined to be associated with the content. As a specific example, user activity may correspond to User A authoring a document relating to Topic A. User A's identification (e.g., name or user id), Topic A, and User A's knowledge level of Topic A (as determined by the knowledge determination mechanism) are provided to the index. The index stores the provided information as one or more data objects (e.g., an array, a hash, a tuple).

At operation 308, a collaboration circle is determined for users. In examples, a collaboration mechanism, such as relationship assessment subsystem 210, accesses user communications and/or user activity data for users who are members of the data domain. The user communications and/or user activity data may be accessed via applications and services of the data domain (e.g., applications and services implemented within and for use by members of the data domain). As a specific example, the collaboration mechanism accesses user email messages, chat messages, phone recordings, and meeting transcriptions. The collaboration mechanism also accesses content to identify user comments, user notes, and other communication between users. Based on the user communications and/or user activity data, the collaboration mechanism determines the users with whom each user typically communicates. The determination may be based on a total number of communications, a frequency of communications, a length of communications, a topic of communications, or the like. In examples, when a user that satisfies a minimum communication threshold for communicating with another user, each of the users is added to the collaboration circle of the other user. For instance, if the communications of User A and User B exceed a minimum communication threshold (e.g., five communications of any type per month), User A is added to User B's collaboration circle and User B is added to User A's collaboration circle.

At operation 310, users having knowledge on topics associated with new content are identified. In examples, the monitoring component detects new user activity for the data domain. For instance, a user who is a member of the data domain may be actively authoring a new document. In response to detecting the new user activity, the topic classification mechanism evaluates the new content associated with the new user activity to determine the topic(s) associated with the new content. A user identification mechanism, such as expert selection subsystem 212, compares the topic(s) associated with the new content to the topics in the index. When a topic associated with the new content is determined to match (or be similar to) a topic in the index, the user identification mechanism identifies users that are associated with the topic in the index. The identification mechanism also identifies the knowledge levels on the topic for the identified users. As a specific example, Topic A may be associated with new content. The index may comprise two entries for Topic A: “User A; Topic A; Expert” and “User B; Topic A; Novice.” Accordingly, the identification mechanism may identify both entries and may retrieve the corresponding information form the index (e.g., “User A; Expert” and “User B; Novice”).

At operation 312, the identified users having knowledge on topics associated with new content are ranked. In examples, the user identification mechanism ranks the identified users based on one or more factors, such as the degree of overlap between a topic and an identified user's areas of knowledge, the level of an identified user's knowledge on a topic, the number of identified user's having knowledge on a topic, whether an identified user has access to the new content, whether the identified user is outside the collaboration circle of the user associated with the new user activity, whether the identified user has acted on selection notifications previously, and other information about the identified user (e.g., amount of time with the organization, years of professional experience, number of publications, number and/or type of awards, educational details, role or title). As a specific example, Topic A and Topic B are associated with new content. Topic A represents a generic and/or well-known topic and several users in the data domain have expert knowledge of Topic A, whereas Topic B represents an esoteric and/or unknown topic and few users in the data domain have expert knowledge (or even intermediate knowledge) of Topic B. In accordance with a ranking rule that prioritizes finding experts for topics for which there are few experts over finding experts for topics for which there are more experts, user identification mechanism ranks users having expert knowledge of Topic B higher than users having expert knowledge of Topic A.

In at least one example, ranking the identified users comprises providing scores and/or weights for the identified users. The scores and/or weights may indicate a ranking preference for a ranking factor or an identified user. For instance, user knowledge levels on topics may be weighted such that a beginner level is assigned a weight of 0.2, an intermediate level is assigned a weight of 0.5, and an expert level is assigned a weight of 0.8 (on a scale of −1.0 to 1.0, where −1.0 indicates a strong preference against, 0.0 indicates no preference, and 1.0 indicates a strong preference for). Additionally, the collaboration circle factor may be weighted such that an identified user who is inside the collaboration circle of the user associated with the new user activity is assigned a weight of −0.2 and an identified user who is outside the collaboration circle of the user associated with the new user activity is assigned a weight of 0.5. In some examples, an identified user who is inside the collaboration circle of the user associated with the new user activity may be removed from the list of identified users.

The user identification mechanism may combine the factor weights to calculate a score for identified users. For instance, User A has an intermediate level of knowledge on Topic A and is outside the collaboration circle of the user associated with the new user activity, whereas User B has an expert level of knowledge on Topic A and is inside the collaboration circle of the user associated with the new user activity. The user identification mechanism may calculate a score for User A (e.g., (knowledge level=0.5)+(collaboration circle=0.5)=1.0) and a score for User B (e.g., (knowledge level=0.8)+(collaboration circle=−0.2)=0.6), then rank the identified users based on their respective scores (e.g., User A with a score 1.0 is ranked higher than User B with a score of 0.6). In aspects, after ranking the identified users, the user identification mechanism selects one or more of the identified users based on selection criteria. For instance, the identified user having the highest score may be selected, the top ‘N’ or ‘N’% of identified users may be selected, all of the identified users that are experts on the topic may be selected, and so on.

At operation 314, notifications associated with the new user activity are provided to users. In examples, a notification mechanism, such as notification surfacing subsystem 214 provides each identified user that is selected (“selected user”) a notification about the new content. A notification may comprise the name or identifier of the content, topics in the content, the name of the authoring user, an identifier of the authoring user's organization, a means to contact the authoring user, and/or other metadata about the content. In one example, the notification also comprises the new content or a portion of the new content. Alternatively, the new content (or the portion thereof) may be provided along with, but external to, the notification. In some examples, the notification mechanism additionally or alternatively provides a notification to one or more users associated with the new user activity. A notification may comprise the name of the selected user, background information for the selected user, relevant content authored or modified by the selected user, a means to contact the selected user, and/or a score for the selected user. The notification may also comprise an option that enables a user associated with the new user activity to request assistance from one or more selected users. In examples, the notifications may be provided as email messages, text messages, organization internal feeds, pop-ups, and the like. In one example, the notification mechanism provides a user interface that enables a selected user to view, edit, comment on, and/or navigate the content.

FIGS. 4-7 and the associated descriptions provide a discussion of a variety of operating environments in which aspects of the disclosure may be practiced. However, the devices and systems illustrated and discussed with respect to FIGS. 4-7 are for purposes of example and illustration, and, as is understood, a vast number of computing device configurations may be utilized for practicing aspects of the disclosure, described herein.

FIG. 4 is a block diagram illustrating physical components (e.g., hardware) of a computing device 400 with which aspects of the disclosure may be practiced. The computing device components described below may be suitable for the computing devices and systems described above. In a basic configuration, the computing device 400 includes at least one processing unit 402 and a system memory 404. Depending on the configuration and type of computing device, the system memory 404 may comprise volatile storage (e.g., random access memory), non-volatile storage (e.g., read-only memory), flash memory, or any combination of such memories.

The system memory 404 includes an operating system 405 and one or more program modules 406 suitable for running software application 420, such as one or more components supported by the systems described herein. The operating system 405, for example, may be suitable for controlling the operation of the computing device 400.

Furthermore, embodiments of the disclosure may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may include additional data storage devices (removable and/or non-removable) such as, for example, magnetic disks, optical disks, tape, and other computer readable media. Such additional storage is illustrated in FIG. 4 by a removable storage device 407 and a non-removable storage device 410.

The term computer readable media as used herein includes computer storage media. Computer storage media includes volatile and nonvolatile, removable and non-removable media implemented in any method or technology for storage of information, such as computer readable instructions, data structures, or program modules. The system memory 404, the removable storage device 407, and the non-removable storage device 410 are all computer storage media examples (e.g., memory storage). Computer storage media may include random access memory (RAM), read-only memory (ROM), electrically erasable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

As stated above, a number of program modules and data files may be stored in the system memory 404. While executing on the processing unit 402, the program modules 406 (e.g., application 420) may perform processes including the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 400 on the single integrated circuit (chip). Embodiments of the disclosure may also be practiced using other technologies capable of performing logical operations such as, for example, AND, OR, and NOT, including mechanical, optical, fluidic, and quantum technologies. In addition, embodiments of the disclosure may be practiced within a general-purpose computer or in any other circuits or systems.

The computing device 400 may also have one or more input device(s) 412 such as a keyboard, a mouse, a pen, a sound or voice input device, a touch or swipe input device, etc. Output device(s) 414 such as a display, speakers, a printer, etc. may also be included. The aforementioned devices are examples and others may be used. The computing device 400 may include one or more communication connections 416 allowing communications with other computing devices 440. Examples of suitable communication connections 416 include radio frequency (RF) transmitter, receiver, and/or transceiver circuitry; universal serial bus (USB), parallel, and/or serial ports.

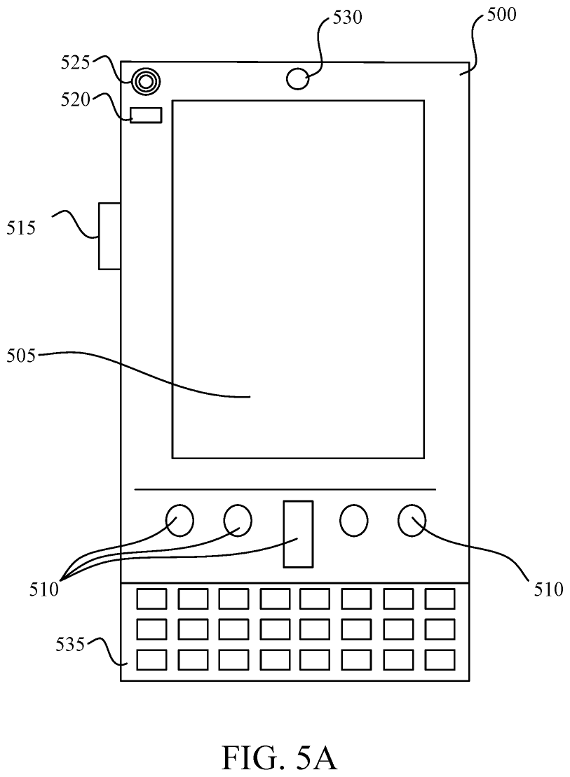

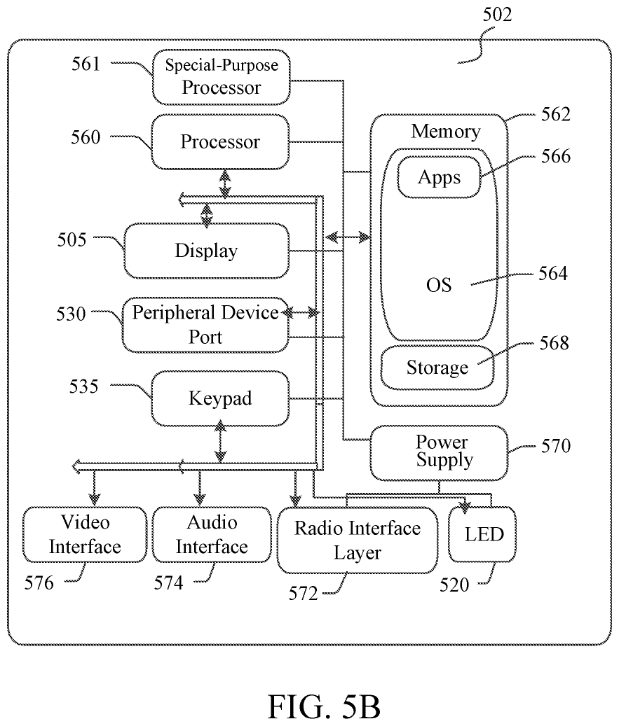

FIGS. 5A and 5B illustrate a mobile computing device 500, for example, a mobile telephone (e.g., a smart phone), wearable computer (such as a smart watch), a tablet computer, a laptop computer, and the like, with which embodiments of the disclosure may be practiced. In some aspects, the client device is a mobile computing device. With reference to FIG. 5A, one aspect of a mobile computing device 500 for implementing the aspects is illustrated. In a basic configuration, the mobile computing device 500 is a handheld computer having both input elements and output elements. The mobile computing device 500 typically includes a display 505 and may include one or more input buttons 510 that allow the user to enter information into the mobile computing device 500. The display 505 of the mobile computing device 500 may also function as an input device (e.g., a touch screen display).

If included, an optional side input element 515 allows further user input. The side input element 515 may be a rotary switch, a button, or any other type of manual input element. In alternative aspects, mobile computing device 500 incorporates more or less input elements. For example, the display 505 may not be a touch screen in some embodiments.

In yet another alternative embodiment, the mobile computing device 500 is a mobile telephone, such as a cellular phone. The mobile computing device 500 may also include an optional keypad 535. Optional keypad 535 may be a physical keypad or a “soft” keypad generated on the touch screen display.

In various embodiments, the output elements include the display 505 for showing a graphical user interface (GUI), a visual indicator 520 (e.g., a light emitting diode), and/or an audio transducer 525 (e.g., a speaker). In some aspects, the mobile computing device 500 incorporates a vibration transducer for providing the user with tactile feedback. In yet another aspect, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one aspect of a mobile computing device. That is, the mobile computing device can incorporate a system (e.g., an architecture) 502 to implement some aspects. In one embodiment, the system 502 is implemented as a “smart phone” capable of running one or more applications (e.g., browser, e-mail, calendaring, contact managers, messaging clients, games, and media clients/players). In some aspects, the system 502 is integrated as a computing device, such as an integrated personal digital assistant (PDA) and wireless phone.

One or more application programs 566 may be loaded into the memory 562 and run on or in association with the operating system (OS) 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 566 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device described herein (e.g., search engine, extractor module, relevancy ranking module, answer scoring module).

The system 502 has a power supply 570, which may be implemented as one or more batteries. The power supply 570 might further include an external power source, such as an AC adapter or a powered docking cradle that supplements or recharges the batteries.

The system 502 may also include a radio interface layer 572 that performs the function of transmitting and receiving radio frequency communications. The radio interface layer 572 facilitates wireless connectivity between the system 502 and the “outside world,” via a communications carrier or service provider. Transmissions to and from the radio interface layer 572 are conducted under control of the operating system 564. In other words, communications received by the radio interface layer 572 may be disseminated to the application programs 566 via the OS 564, and vice versa.

The visual indicator (e.g., light emitting diode (LED) 520) may be used to provide visual notifications, and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor(s) (e.g., processor 560 and/or special-purpose processor 561) and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present disclosure, the microphone also serves as an audio sensor to facilitate control of notifications, as will be described below. The system 502 may further include a video interface 576 that enables an operation of a peripheral device port 530 (e.g., an on-board camera) to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio interface layer 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio interface layer 572 or via a distributed computing network. Similarly, such data may be readily transferred between computing devices for storage and use according to well-known data transfer and storage means, including electronic mail and collaboration data sharing systems.

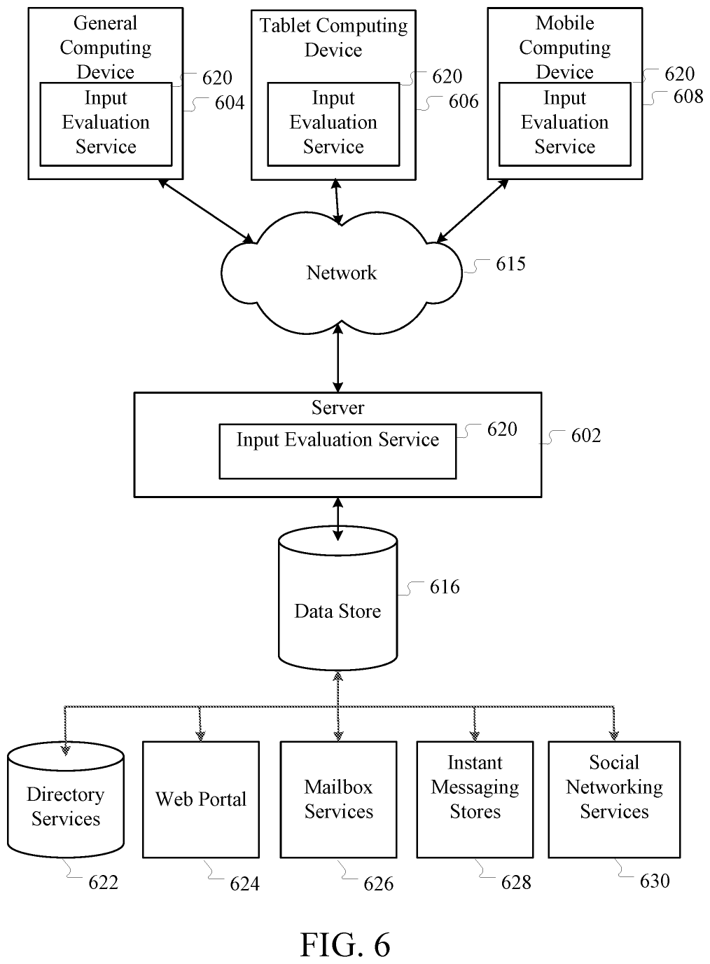

FIG. 6 illustrates one aspect of the architecture of a system for processing data received at a computing system from a remote source, such as a personal computer 604, tablet computing device 606, or mobile computing device 608, as described above. Content displayed at server device 602 may be stored in different communication channels or other storage types. For example, various documents may be stored using directory services 622, web portals 624, mailbox services 626, instant messaging stores 628, or social networking services 630.

An input evaluation service 620 may be employed by a client that communicates with server device 602, and/or input evaluation service 620 may be employed by server device 602. The server device 602 may provide data to and from a client computing device such as a personal computer 604, a tablet computing device 606 and/or a mobile computing device 608 (e.g., a smart phone) through a network 615. By way of example, the computer system described above may be embodied in a personal computer 604, a tablet computing device 606 and/or a mobile computing device 608 (e.g., a smart phone). Any of these embodiments of the computing devices may obtain content from the data store 616, in addition to receiving graphical data useable to be either pre-processed at a graphic-originating system, or post-processed at a receiving computing system.

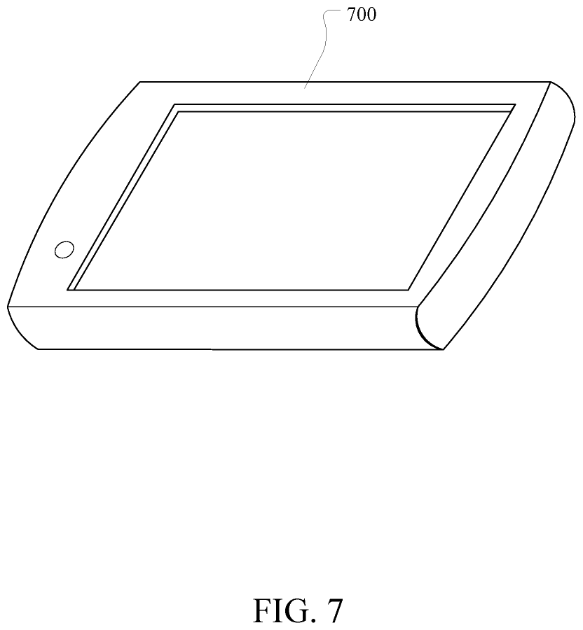

FIG. 7 illustrates an example of a tablet computing device 700 that may execute one or more aspects disclosed herein. In addition, the aspects and functionalities described herein may operate over distributed systems (e.g., cloud-based computing systems), where application functionality, memory, data storage and retrieval, and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
a processor; and
memory coupled to the processor, the memory comprising computer executable instructions that, when executed by the processor, perform a method comprising:
evaluating first content associated with a data domain to determine a first set of topics for the first content;
determining user knowledge levels for the first set of topics;
maintaining an index comprising the first set of topics, the user knowledge levels, and users associated with the user knowledge levels;
determining a set of collaboration circles for users within the data domain;
in response to detecting second content associated with the data domain, identifying users having knowledge on a second set of topics for the second content, wherein the identifying comprises comparing the second set of topics to the first set of topics in the index;
ranking the users having knowledge on the second set of topics based at least on the set of collaboration circles; and
providing a notification associated with the second content to the users having knowledge on the second set of topics.

2. The system of claim 1, wherein the data domain is a logical grouping of information for an organization, the first content being created or controlled by members of the organization.

3. The system of claim 1, wherein evaluating the first content comprises applying a machine learning (ML) analysis technique to the first content, the ML analysis technique including at least one of named entity recognition, speech tagging, or syntactic parsing.

4. The system of claim 3, wherein applying the ML analysis technique comprises scanning sentences in a paragraph of the first content to determine a common topic of the paragraph.

5. The system of claim 3, wherein applying the ML analysis technique comprises scanning at least one of section identification information or data fields of the first content, the section identification information comprising at least one of a content title, a section identifier, or a table of contents.

6. The system of claim 3, wherein applying the ML analysis technique comprises scanning metadata of the content, the metadata comprising at least one of a content keyword, a content summary, or a content file name.

7. The system of claim 1, wherein the user knowledge levels for the first set of topics are based on at least one of:
an amount of communication a user has engaged in regarding a topic;
a number of other users with whom a user has communicated about a topic; or
an amount of time over which communications about a topic have occurred.

8. The system of claim 1, wherein determining the set of collaboration circles comprises evaluating user communications for users who are members of the data domain to determine with whom the users who are members of the data domain communicate.

9. The system of claim 8, wherein evaluating the user communications comprises determining at least one of:
a total number of the user communications;
a frequency of the user communications;
a length of the user communications; or
a topic of the user communications.

10. The system of claim 1, wherein detecting second content comprises:
during composition of the second content, evaluating a first portion of the second content; and
determining the second set of topics for the second content.

11. The system of claim 1, wherein comparing the second set of topics to the first set of topics in the index comprises:
matching topics in the second set of topics to topics in the first set of topics to create matched topics; and
for each matched topic, identifying one or more users in the index that are indicated in the index as having knowledge on the matched topic.

12. The system of claim 1, wherein ranking the users having knowledge on the second set of topics is further based on a level of knowledge on the second set of topics for each of the users having knowledge on the second set of topics.

13. The system of claim 12, wherein ranking the users having knowledge on the second set of topics is further based on at least one of:
a degree of overlap between the second set of topics and areas of knowledge for each of the users having knowledge on the second set of topics; or
a count of the users having knowledge on the second set of topics.

14. The system of claim 1, wherein the notification associated with the second content comprises:
the second set of topics;
an identifier of the second content; and
an identifier of name an authoring user of the second content.

15. A method comprising:
evaluating first content associated with a data domain to determine a first topic for the first content;
determining user knowledge levels on the first topic for members of the data domain;
storing in an index the first topic, the user knowledge levels on the first topic, and a set of members from the members of the data domain that are knowledgeable about the first topic;
determining a set of collaboration circles for the members of the data domain;
detecting second content associated with the data domain, wherein the second content is associated with the first topic;
identifying in the index the set of members that are knowledgeable about the first topic
ranking the set of members; and
providing a notification of the set of members to a user associated with the second content.

16. The method of claim 15, wherein detecting the second content comprises:
monitoring the data domain for user activity, the user activity including creating or modifying content; and
detecting the user activity for the second content, wherein the user activity is performed by the user associated with the second content.

17. The method of claim 15, wherein ranking the set of members comprises determining whether each of the set of members inside a collaboration circle of the set of collaboration circles for the user associated with the second content.

18. The method of claim 17, wherein a member of the set of members who is determined to be inside the collaboration circle for the user associated with the second content is removed from the set of members.

19. The method of claim 15, wherein the notification comprises an identifier for each member of the set of members at least one of:
background information for each member of the set of members; or
a means to contact each member of the set of members.

20. A device comprising:
a processor; and
memory coupled to the processor, the memory comprising computer executable instructions that, when executed by the processor, perform a method comprising:
determining user knowledge levels on a first topic;
detecting content associated with a data domain, wherein at least a portion of the content is related to the first topic;
identifying a set of users that are knowledgeable about the first topic, wherein the identifying includes accessing a data store comprising the set of users and the user knowledge levels on the first topic;
ranking the set of users to identify a most knowledgeable user on the first topic; and
providing a notification of the content to the most knowledgeable user on the first topic.
